(19) United States
(12) Patent Application Publication
(10) Pub. No.: US 2004/0182078 A1
(43) Pub. Date: Sep. 23, 2004

(54) Proportional bypass valve, system and method of using with a turbocharged internal combustion engine

(75) Inventor: Stavros Tsokonas, Chatham (CA)

Correspondence Address: MORGAN LEWIS & BOCKIUS LLP, 1111 PENNSYLVANIA AVENUE NW, WASHINGTON, DC, 20004, US

(73) Assignee: Siemens VDO Automotive, Incorporated

(21) Appl. No.: 10/805,520

(22) Filed: Mar. 22, 2004

Related U.S. Application Data
(60) Provisional application No. 60/456,377, filed on Mar. 21, 2003.

(51) Int. Cl. F02B 33/44

(52) U.S. Cl. 60/605.1; 60/602

(57) ABSTRACT

A fluid flow regulator for a turbocharged internal combustion engine includes a body and a valve. The body defines a chamber and includes first, second and third ports. The chamber is in fluid communication with the first, second and third ports. A first fluid flow path passes through the first port, through the chamber and through the second port. A second fluid flow path passes through the first port, through the chamber and through the third port. The valve includes a head that is disposed in the chamber. The valve is movable between first and second configurations with respect to the body. The first configuration substantially occludes the second fluid flow path, the second configuration substantially occludes the first fluid flow path, and the plurality of intermediate configurations permit restricted fluid flow along the first and second fluid flow paths.

### CROSS REFERENCE TO RELATED APPLICATIONS

This application claims the benefit of the earlier filing date of U.S. Provisional Application No. 60/456,377, filed 21 Mar. 2003, which is incorporated by reference herein in its entirety.

### FIELD OF THE INVENTION

The present invention may be used in any application that uses a bypass valve. In particular, the present invention is directed to a proportional bypass valve for use on a motor vehicle, e.g., to regulate pressure to a wastegate actuator in a turbocharger system in order to control turbocharger boost.

### BACKGROUND OF THE INVENTION

An internal combustion engine that is not equipped with a turbocharger system relies on the suction created by the intake stroke of a piston in a combustion cylinder to draw into the cylinder a charge of fresh air. Thus, air from the atmosphere (higher pressure) moves into the cylinder by virtue of the cylinder having a lower pressure than atmosphere. The air is mixed with fuel, e.g., gasoline, and the mixture is ignited so as to burn in the cylinder. The resulting combustion products, e.g., carbon dioxide, water, nitrogen oxides, and unburned hydrocarbons, are then expelled from the cylinder.

A turbocharger system uses residual energy in the exhaust gas to “boost” or positively pressurize the air that is drawn into the cylinder. Thus, a charge of air that is more dense is pushed into the combustion cylinder of a turbocharged internal combustion engine.

A wastegate is used to limit the maximum boost that a turbocharger system supplies to an internal combustion engine. A known turbocharger system uses a spring-loaded pop-off valve type wastegate to limit the maximum boost of the turbocharger. The level of boost is directly related to the operation of such a wastegate. However, rapid fluctuations of the boost can result in undesirable surging of the internal combustion engine, and possible over-pressurization of the engine intake system that could possibly result in engine damage.

Therefore, it is believed that there is a need to provide an apparatus, system, and method of regulating the actuation of a wastegate for a turbocharged internal combustion engine.

### SUMMARY OF THE INVENTION

The present invention provides a fluid flow regulator that includes a body and a valve. The body defines a chamber and includes first, second and third ports. The chamber is in fluid communication with the first, second and third ports. A first fluid flow path passes through the first port, through the chamber and through the second port. A second fluid flow path passes through the first port, through the chamber and through the third port. The valve includes a head that is disposed in the chamber. The valve is movable between first and second configurations with respect to the body. The first configuration substantially occludes the second fluid flow path and the second configuration substantially occludes the first fluid flow path.

The present invention also provides a fluid flow controller for a turbocharger on an internal combustion engine. The turbocharger boosts density of atmospheric air that is supplied to the internal combustion engine. A wastegate sets a maximum boost level. The fluid flow controller includes a body that defines a chamber, and a valve having a head disposed in the chamber. The body includes an inlet port that provides fluid communication between the turbocharger and the chamber, a first outlet port that provides fluid communication between the chamber and the wastegate, and a second outlet port that provides fluid communication between the chamber and the atmosphere. A first fluid flow path passes air from the turbocharger through the inlet port, through the chamber and out the first outlet port to the wastegate. A second fluid flow path passes air from the turbocharger through the inlet port, through the chamber and out the second outlet port to the atmosphere. The valve is movable with respect to the body between a first configuration, a second configuration, and a plurality of intermediate configurations. The first configuration substantially occludes the second fluid flow path and permits generally unrestricted fluid flow along the first fluid flow path. The second configuration substantially occludes the first fluid flow path and permits generally unrestricted fluid flow along the second fluid flow path. And the pluralities of intermediate configurations permit proportional fluid flow along the first and second fluid flow paths.

The present invention also provides a system of boosting the density of atmospheric air that is supplied to an internal combustion engine. The internal combustion engine includes an intake manifold, which provides the air to a combustion cylinder, and includes an exhaust manifold, which provides combustion products from the combustion cylinder. The system includes a turbocharger, a wastegate, and a fluid flow controller. The turbocharger includes a turbine and a compressor that is connected for rotation with the turbine. The turbine is in fluid communication with the exhaust manifold, and the compressor is in fluid communication with the intake manifold. The wastegate includes a regulating portion and a control portion. The regulating portion is in fluid communication between the compressor and the atmosphere. The control portion is operatively coupled to the regulating portion and receives a fluid control signal. The fluid flow controller supplies the fluid control signal to the wastegate and includes a body that defines a chamber, a valve that includes a head disposed in the chamber. The body includes an inlet port that provides fluid communication between the turbocharger and the chamber, a first outlet port that provides fluid communication between the chamber and the wastegate, and a second outlet port providing fluid communication between the chamber and the atmosphere. A first fluid flow path passes air from the turbocharger through the inlet port, through the chamber and out the first outlet port to the wastegate. A second fluid flow path passes air from the turbocharger through the inlet port, through the chamber and out the second outlet port to the atmosphere. The valve is movable with respect to the body between a first configuration, a second configuration, and a plurality of intermediate configurations. The first configuration substantially occludes the second fluid flow path and permits generally unrestricted fluid flow along the first fluid flow path. The second configuration substantially occludes the first fluid flow path and permits generally unrestricted fluid flow along the second fluid flow path. And the pluralities of intermediate configurations permit proportional fluid flow along the first and second fluid flow paths.

The present invention also provides a method of controlling a wastegate for a turbocharger on an internal combustion engine. The turbocharger boosts the density of atmospheric air that is supplied to the internal combustion engine. The wastegate sets a maximum boost level of the turbocharger. The method includes supplying air from the turbocharger to a fluid flow controller, sending a control signal (e.g., a first portion of the air supplied to the fluid flow controller from the turbocharger) from the fluid flow controller to the wastegate, discharging to the atmosphere a second portion of the air that is supplied from the turbocharger to the fluid flow controller, and proportioning the first and second portions of the air.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a cross-section showing a proportional bypass valve in accordance with the detailed description of a preferred embodiment.

FIG. 2 is a schematic illustration of a turbocharging system including the proportional bypass valve shown in FIG. 1.

### DETAILED DESCRIPTION OF THE PREFERRED EMBODIMENT

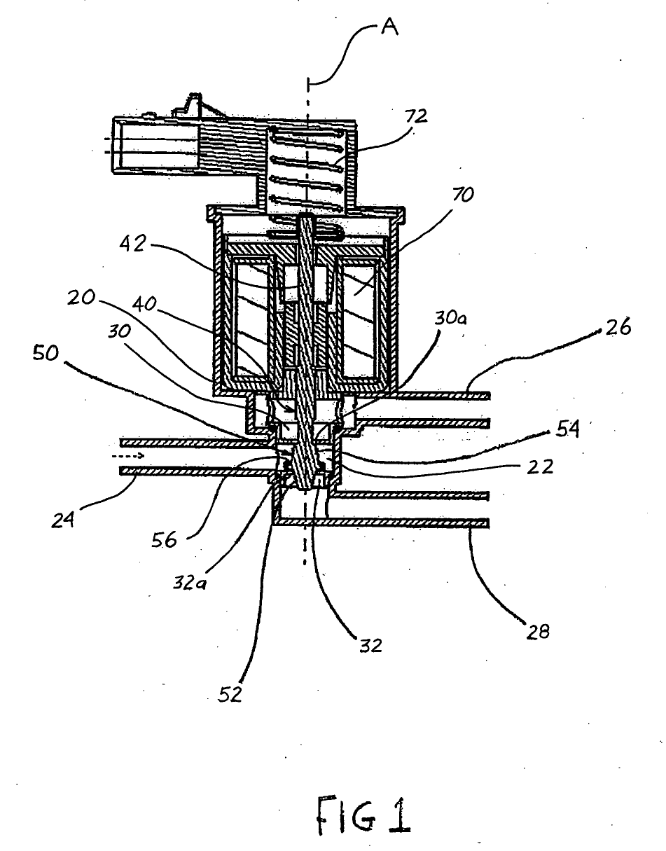

FIG. 1 shows a fluid flow regulator 10 that includes a body 20 and a valve 40. The body 20 defines a chamber 22. The body 20 including a first port 24, a second port 26 and third port 28, each of which are in fluid communication with the chamber 22.

A first fluid flow path passes through the first port 24, through the chamber 22, and through the second port 26. A second fluid flow path passes through the first port 24, through the chamber 22, and through the third port 28.

The body 20 includes a first seat 30 and a second seat 32. The first fluid flow path passes though the first seat 30, and the second fluid flow path passes through the second seat 32. The first seat 30 is disposed in the chamber 22 and defines a first aperture 30a with a first area, and the second seat 32 is disposed in the chamber 22 and defines a second aperture 32a with a second area. Preferably, the first aperture 30a is round with a first aperture diameter, and the second aperture 32a is also round with a second aperture diameter, which may the same as or different from the first aperture diameter. The first and second seats 30,32 are centered about an axis A, and the first seat 30 is spaced along the axis A with respect to the second seat 32.

The valve 40 includes a stem 42 and a head 50. The stem 40 penetrates the body 20 and is fixedly coupled to the head 50, which is disposed in the chamber 22. The valve 40 is movable between first and second configurations with respect to the body 20. The first configuration occurs when the second fluid flow path is substantially occluded, e.g., when the head 50 sealingly engages the second seat 32, and the second configuration occurs when the first fluid flow path is substantially occluded, e.g., when the head 50 sealingly engages the first seat 30.

The valve 40 moves along the axis A and the head 50 is disposed along the axis A between the first and second seats 30,32. An actuator 70 is operably coupled to the stem 42 and moves the stem 42 and the head 50 between the first and second configurations for the fluid flow regulator 10. Preferably, the actuator 70 comprises an electromagnetic actuator, e.g., a solenoid, that is mounted on the body 20. A resilient element 72, e.g., a compression spring, biases the stem 42 toward the first configuration of the fluid flow regulator 10.

The head 50 of the actuator includes a first portion 52 that disposed at an axial end of the valve 40, a second portion 54 that is disposed along the axis A between the first portion 52 and the stem 42, and a central portion 56 that is disposed along the axis A between the first and second portions 52,54.

The central portion 56 has a cross-section area, taken transverse to the axis A, that is greater than the first area of the first aperture 30a of the first seat 30, and is also greater than the second area of the second aperture 32a of the second seat 32. According to a preferred embodiment, the central portion 56 has a round cross-section with a diameter that is greater than the diameter of the first aperture 30a, and is also greater than the diameter of the second aperture 32a.

The first portion 52 tapers along the axis A to a minimum first portion diameter that is less than the diameter of the first aperture 30a, and the second portion 54 tapers along the axis A to a minimum second portion diameter that is less than the diameter of the second aperture 32a. Preferably, the stem 42 has a diameter that is no greater than the minimum second portion diameter.

The valve 40 is movable to a plurality of intermediate configurations between the first and second configurations of the valve 40. Preferably, this movement of the valve 40 is infinitely variable. The pluralities of intermediate configurations permit simultaneous fluid flow along the first and second fluid flow paths. Specifically, the first configuration of the valve 40 permits generally unrestricted fluid flow along the first fluid flow path, the second configuration of the valve 40 permit generally unrestricted fluid flow along the second fluid flow path, and the plurality of intermediate configurations permit restricted fluid flow along the first and second fluid flow paths.

Preferably, the valve seats 30,32 and valve head 50 are sized and contoured to cause a linear proportioning of pressure with respect to the positioning of the valve 40 in the body 20. For example, fluid flow along the first fluid flow path may be inversely proportional to the fluid flow along the second fluid flow path, e.g., if the fluid flow along the first fluid flow path is increased by ten percent then the fluid flow along the second fluid flow path would decrease by ten percent. The dimensions and relative tapers of the first and second portions 52,54 and the dimensions of the valve seats 30,32 may be selected so as to adjust the proportioning of the fluid flow along the first and second fluid flow paths.

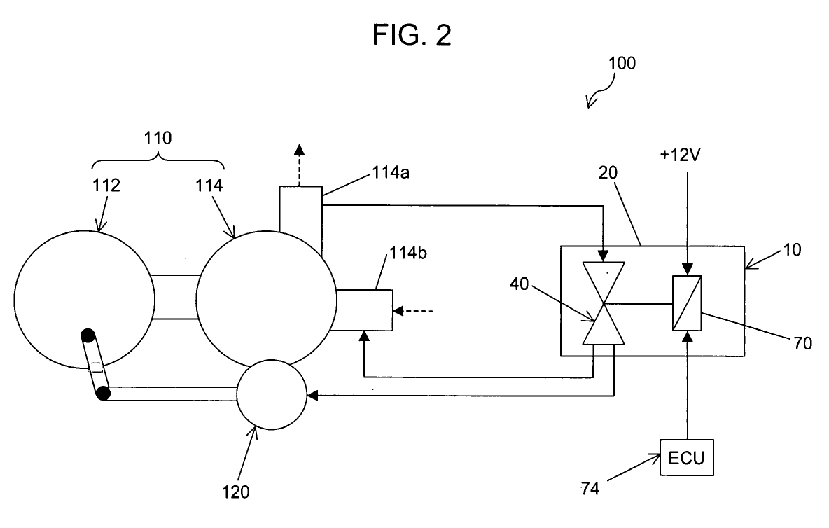

Referring additionally to FIG. 2, a system 100 of boosting atmospheric air density, which uses a proportional pressure regulator 10, will now be described. The system 100 supplies boost to an internal combustion engine (not show) that includes an intake manifold (not shown), which provides a fresh charge of the air to a combustion cylinder (not shown), and includes an exhaust manifold (not shown) through which combustion products are withdrawn from the combustion cylinder. The system includes a turbocharger 110, a wastegate actuator 120, and a proportional pressure regulator such as the fluid flow regulator 10.

The turbocharger 110 includes a turbine 112 and a compressor 114, which is connected for rotation with the turbine 112. The turbine 112 is in fluid communication with the exhaust manifold (not shown), and the compressor 114 is in fluid communication with the intake manifold (not shown).

The wastegate actuator 120 preferably includes a pneumatic pressure to mechanical device. The proportional pressure fluid flow regulator 10 is in fluid communication between the compressor outlet 114a on one side, and the wastegate actuator 120 and the atmosphere inlet 114b on the other side.

A method will now be discussed for controlling the wastegate 120 for the turbocharger 110 on an internal combustion engine (not shown). Preferably, the method includes supplying air from the turbocharger 110 to the fluid flow controller 10. A control pneumatic signal is sent from the fluid flow controller 10 to the wastegate 120. This control signal is a first portion of the air supplied from the turbocharger 110 to the fluid flow controller 10. A second portion of the air supplied from the turbocharger 110 to the fluid flow controller 10 is discharged to the atmosphere. The fluid flow controller 10 is adjusted to proportion the first and second portions of the air. Preferably, the fluid flow controller 10 is adjusted by an electronic control unit 74, e.g., an engine control unit, supplying an electric signal to the electromagnetic actuator 70.

Advantages of the present invention include that the valve allows linear or proportional redirection of flow pressure or vacuum from a selected port to another. In the case of a turbocharger system, a valve according to the present invention regulates pressure to a wastegate actuator in order to control turbocharger boost.

A fluid flow regulator 10 according to the present invention can accomplish accurate linear control, by virtue of the relative geometry of the head 50 and the first and second seats 30,32.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What is claimed is:

1. A fluid flow regulator comprising:
a body defining a chamber, the body including first, second and third ports, and the chamber being in fluid communication with the first, second and third ports, a first fluid flow path passing through the first port, through the chamber and through the second port, and a second fluid flow path passing through the first port, through the chamber and through the third port;
a valve including a head disposed in the chamber, the valve being movable between first and second configurations with respect to the body, the first configuration substantially occluding the second fluid flow path and the second configuration substantially occluding the first fluid flow path.

2. The fluid flow regulator according to claim 1, wherein the body comprises first and second seats, the first fluid flow path passes though the first seat when the head sealingly engages the second seat in the first configuration of the valve, and the second fluid flow path passes through the second seat when the head sealingly engages the first seat in the second configuration of the valve.

3. The fluid flow regulator according to claim 2, wherein the first seat is disposed in the chamber and defines a first aperture with a first area, and the second seat is disposed in the chamber and defines a second aperture with a second area.

4. The fluid flow regulator according to claim 3, wherein the first and second seats are centered about an axis, and the first seat is spaced along the axis with respect to the second seat.

5. The fluid flow regulator according to claim 4, wherein the valve moves along the axis and the head is disposed along the axis between the first and second seats.

6. The fluid flow regulator according to claim 4, wherein the valve comprises a stem that is fixed to the head and projects through the body.

7. The fluid flow regulator according to claim 6, further comprising:
an actuator operably coupled to the stem, the actuator moves the head and stem between the first and second configurations of the valve.

8. The fluid flow regulator according to claim 7, wherein the actuator comprises an electromagnetic actuator mounted on the body.

9. The fluid flow regulator according to claim 7, wherein the actuator comprises a resilient element biasing the stem toward the first configuration of the valve.

10. The fluid flow regulator according to claim 4, wherein the head reciprocates along the axis between the first and second configurations of the valve.

11. A fluid flow regulator according to claim 10, wherein the head comprises:
a first portion disposed at an axial end of the valve;
a second portion disposed along the axis between the first portion and the stem; and
a central portion disposed along the axis between the first and second portions.

12. The fluid flow regulator according to claim 11, wherein the central portion has a cross-section area transverse to the axis, and the cross-section area is greater than the first area of the first aperture of the first seat and is greater than the second area of the second aperture of the second seat.

13. The fluid flow regulator according to claim 11, wherein the central portion has a diameter that is greater than a diameter of the first aperture and greater than a diameter of the second aperture.

14. The fluid flow regulator according to claim 13, wherein the first portion tapers along the axis to a minimum first portion diameter that is less than the diameter of the first aperture, and the second portion tapers along the axis to a minimum second portion diameter that is less than the diameter of the second aperture.

15. The fluid flow regulator according to claim 14, wherein a diameter of the stem is no greater than the minimum second portion diameter.

16. The fluid flow regulator according to claim 1, wherein the valve is movable to a plurality of intermediate configurations between the first and second configurations of the valve.

17. The fluid flow regulator according to claim 16, wherein movement of the valve among the plurality of intermediate configurations is infinitely variable.

18. The fluid flow regulator according to claim 16, wherein the plurality of intermediate configurations permits fluid flow along the first and second fluid flow paths.

19. The fluid flow regulator according to claim 18, wherein the first configuration of the valve permits generally unrestricted fluid flow along the first fluid flow path, the second configuration of the valve permits generally unrestricted fluid flow along the second fluid flow path, and the plurality of intermediate configurations permits restricted fluid flow along the first and second fluid flow paths.

20. A fluid flow controller for a turbocharger on an internal combustion engine, the turbocharger boosting density of atmospheric air being supplied to the internal combustion engine, and a wastegate setting a maximum boost level, the fluid flow controller comprising:
a body defining a chamber, the body including:
an inlet port providing fluid communication between the turbocharger and the chamber;
a first outlet port providing fluid communication between the chamber and the wastegate, a first fluid flow path passing air from the turbocharger through the inlet port, through the chamber and out the first outlet port to the wastegate; and
a second outlet port providing fluid communication between the chamber and the atmosphere, a second fluid flow path passing air from the turbocharger through the inlet port, through the chamber and out the second outlet port to the atmosphere;
a valve including a head disposed in the chamber, the valve being movable with respect to the body between a first configuration, a second configuration, and a plurality of intermediate configurations:
the first configuration substantially occluding the second fluid flow path and permitting generally unrestricted fluid flow along the first fluid flow path;
the second configuration substantially occluding the first fluid flow path and permitting generally unrestricted fluid flow along the second fluid flow path; and
the plurality of intermediate configurations permitting proportional fluid flow along the first and second fluid flow paths.

21. The fluid flow controller according to claim 20, wherein the body comprises first and second seats, the first seat defines a first aperture having a first seat diameter, the second seat defines a second aperture having a second seat diameter, the first fluid flow path passes though the first aperture in the first configuration of the valve, and the second fluid flow path passes through the second aperture in the second configuration of the valve.

21. The fluid flow controller according to claim 20, wherein the valve reciprocates along an axis with respect to the body, the valve comprises:
a first portion disposed at an axial end of the valve;
a second portion disposed along the axis between the first portion and the stem; and
a central portion disposed along the axis between the first and second portions.

22. The fluid flow controller according to claim 21, wherein the central portion has a diameter that is greater than the first seat diameter and greater than the second seat diameter, the first portion tapers along the axis to a minimum first portion diameter that is less than the first seat diameter, and the second portion tapers along the axis to a minimum second portion diameter that is less than the second seat diameter.

23. The fluid flow controller according to claim 20, further comprising:
an electromagnetic actuator mounted on the body, the electromagnetic actuator reciprocating the valve along the axis between the first and second configurations of the valve; and
a resilient element biasing the valve toward the first configuration of the valve.

24. A system of boosting atmospheric air density being supplied to an internal combustion engine, the internal combustion engine including an intake manifold providing the air to a combustion cylinder and including an exhaust manifold providing combustion products from the combustion cylinder, the system comprising:
a turbocharger including a turbine and a compressor connected for rotation with the turbine, the turbine being in fluid communication with the exhaust manifold, and the compressor being in fluid communication with the intake manifold;
a wastegate including a regulating portion and a control portion, the regulating portion being in fluid communication between the compressor and the atmosphere, and the control portion being operatively coupled to the regulating portion and receiving a fluid control signal; and
a fluid flow controller supplying the fluid control signal to the wastegate, the fluid flow controller including:
a body defining a chamber, the body including:
an inlet port providing fluid communication between the turbocharger and the chamber;
a first outlet port providing fluid communication between the chamber and the wastegate, a first fluid flow path passing air from the turbocharger through the inlet port, through the chamber and out the first outlet port to the wastegate; and
a second outlet port providing fluid communication between the chamber and the atmosphere, a second fluid flow path passing air from the turbocharger through the inlet port, through the chamber and out the second outlet port to the atmosphere; and
a valve including a head disposed in the chamber, the valve being movable with respect to the body between a first configuration, a second configuration, and a plurality of intermediate configurations, wherein:
the first configuration substantially occludes the second fluid flow path and permits generally unrestricted fluid flow along the first fluid flow path;
the second configuration substantially occludes the first fluid flow path and permits generally unrestricted fluid flow along the second fluid flow path; and
the plurality of intermediate configurations permit proportional fluid flow along the first and second fluid flow paths.

25. The system according to claim 24, wherein the fluid flow controller comprises an electromagnetic actuator mounted on the body, the electromagnetic actuator reciprocates the valve along the axis between the first and second configurations of the valve

26. The system according to claim 25, further comprising:
an electronic control unit electrically coupled to the electromagnetic actuator, the electronic control unit supplying to the electromagnetic actuator an electric control signal.

27. A method of controlling a wastegate for a turbocharger on an internal combustion engine, the turbocharger boosting the density of atmospheric air supplied to the internal combustion engine, and the wastegate setting a maximum boost level of the turbocharger, the method comprising:
supplying air from the turbocharger to a fluid flow controller;
sending a control signal from the fluid flow controller to the wastegate, the sending including providing a first portion of the air supplied from the turbocharger to the fluid flow controller;
discharging to the atmosphere a second portion of the air supplied from the turbocharger to the fluid flow controller; and
proportioning the first and second portions of the air.

28. The method according to claim 27, wherein the proportioning comprises adjusting the fluid flow controller between a first configuration, a second configuration, and a plurality of intermediate configurations, the first configuration substantially eliminating the first portion of the air, the second configuration substantially eliminating the second portion of the air, and the plurality of intermediate configurations varying relative proportions of the first and second portions.

29. The method according to claim 28, wherein the proportioning comprises infinitely variably varying the relative proportions of the first and second portions.
